(19) United States
(12) Patent Application Publication
(10) Pub. No.: US 2017/0143103 A1
(43) Pub. Date: May 25, 2017

(54) ANTI-WRINKLING PAD AND METHOD

(71) Applicants: Giselle Howard, Statesboro, GA (US); Lorrie King, New York, NY (US); Emma Phillips, New Canaan, CT (US); Joseph Jay DePra, Redding, CT (US)

(72) Inventors: Giselle Howard, Statesboro, GA (US); Lorrie King, New York, NY (US); Emma Phillips, New Canaan, CT (US); Joseph Jay DePra, Redding, CT (US)

(21) Appl. No.: 14/946,009

(22) Filed: Nov. 19, 2015

(51) Int. Cl. A45D 44/22; B29C 43/00

(52) U.S. Cl. CPC A45D 44/22; B29C 43/006; B29K 2083/00

(57) ABSTRACT

Some embodiments described herein provide a revolutionary cosmetic product to reduce the appearance of fine lines and/or wrinkles in a person's skin. In particular, an anti-wrinkle pad may include an anti-wrinkle portion and may have at least one characteristic to reduce an appearance of fine lines and/or wrinkles on a person's skin in an area around the person's chest, torso, neck, face, hands, backside, knees, etc. The anti-wrinkle pad may further include an adhesive substrate affixed to the lower surface of the anti-wrinkle portion and adapted to adhere the anti-wrinkle portion to the person's skin. According to some embodiments, the anti-wrinkle portion is formed by: blending together a plurality of materials; and placing the blended materials into a compression apparatus to form, using heat and/or pressure, the anti-wrinkle portion. According to some embodiments, the anti-wrinkle pad includes a mixture of ingredients that harnessing them to represent a breakthrough, game-changing advance in the field of cosmetics.

### BACKGROUND

This invention relates generally to an apparatus that reduces the appearance of fine lines and/or wrinkles on a person's skin, and, more specifically, to an anti-wrinkling pad having an adhesive substrate.

An increasing amount of imperfections, such as fine lines and/or wrinkles, may appear on a person's skin as he or she ages. Many people prefer to reduce the appearance of such imperfections to achieve a younger and more healthy image. In general, fine lines and/or wrinkles are folds, ridges or creases in a person's skin. In some cases, wrinkles may appear as a result of aging processes such as glycation (which may damage collagen and elastin associated with protein fibers that keep skin firm and elastic), loss of body mass, etc. In addition to aging, wrinkles may be caused by habitual facial expressions, sun damage, smoking, poor hydration, etc., any of which might make a person uncomfortable with his or her appearance. Accordingly, it would be desirable to provide an anti-wrinkling pad which can effectively reduce the appearance of fine lines and/or wrinkles on a person's skin by being applied over a period of time, such as while he or she is sleeping or for a few hours during the day.

### SUMMARY OF THE INVENTION

According to some embodiments, apparatus, methods, and means may be provided to facilitate the reduction of wrinkles by being applied over a period of time, such as while a person sleeps or for a few hours during the day. In some embodiments, an anti-wrinkle pad may include a substantially flat anti-wrinkle portion having an upper surface, a lower surface, a perimeter edge, and having at least one characteristic to reduce wrinkles on a person's skin in an area near the person's chest, torso, neck, face, hands, backside, knees, etc. The anti-wrinkle pad may further include a substantially flat adhesive substrate affixed to the lower surface of the anti-wrinkle portion and adapted to adhere the anti-wrinkle portion to the person's skin, wherein the anti-wrinkle portion and adhesive substrate are arranged in a parallel planer manner in relation to each other. According to some embodiments, the anti-wrinkle pad uses a mixture of ingredients harnessing them to represent a breakthrough, game-changing advance in the field of cosmetics.

A technical effect of some embodiments of the invention is a greatly improved way to reduce the appearance of fine lines and/or wrinkles around a person's chest, torso, neck, face, hands, backside, knees, etc. over a period of time, such as during a person's sleep. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is an overview of a wrinkle reduction environment according to some embodiments of the present invention.

FIG. 2 is a top perspective view of an anti-wrinkle pad according to some embodiments of the present invention.

FIG. 3 is a top plan view of an anti-wrinkle pad according to some embodiments of the present invention.

FIG. 4 is a side plan view of the cross-section 4-4 illustrated in FIG. 3 in accordance with some embodiments.

FIG. 5 is a side plan view of the cross-section 5-5 illustrated in FIG. 3 in accordance with some embodiments.

FIGS. 6 through 8 illustrate the application of an anti-wrinkle pad to a person's skin in accordance with some embodiments.

FIG. 9 illustrates an anti-wrinkle pad manufacturing method according to some embodiments of the present invention.

FIG. 10 illustrates a method of use of an anti-wrinkle pad by a person according to some embodiments of the present invention.

### DETAILED DESCRIPTION

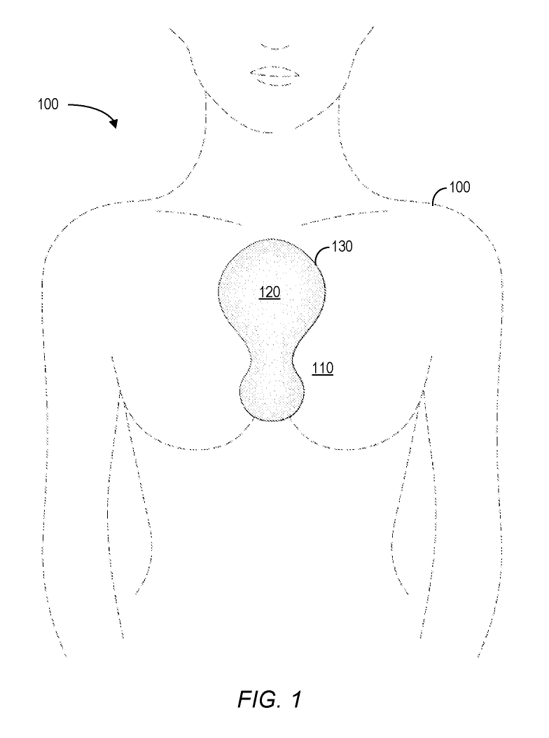

FIG. 1 is an overview of a wrinkle reduction environment 100 according to some embodiments of the present invention. In particular, a person 100 has adhered an anti-wrinkle pad, including an upper surface of an anti-wrinkle portion 120 of the pad, to an area of skin 110 around the chest, torso, neck, face, hands, backside, knees, etc. The substantially flat anti-wrinkle portion 120 may have, according to some embodiments, an upper surface (seen in FIG. 1), a lower surface, a perimeter edge 130, and have at least one characteristic (e.g., a chemical, a shape, an elasticity, etc.) to reduce wrinkles in the area 110 around the person's chest, torso, neck, face, hands, backside, knees, etc. In this way, a person may comfortably wear the pad for an extended period of time (e.g., overnight while the person sleeps or for a few hours during the day) to reduce the appearance of fine lines, wrinkles and/or other skin imperfections. According to some embodiments, the anti-wrinkle pad 110 is formed of a unique and non-obvious product and process using a mixture of ingredients that represent a clear advance over the traditional approaches taken with cosmetics to reduce the appearance of fine lines and/or wrinkles on a person's skin.

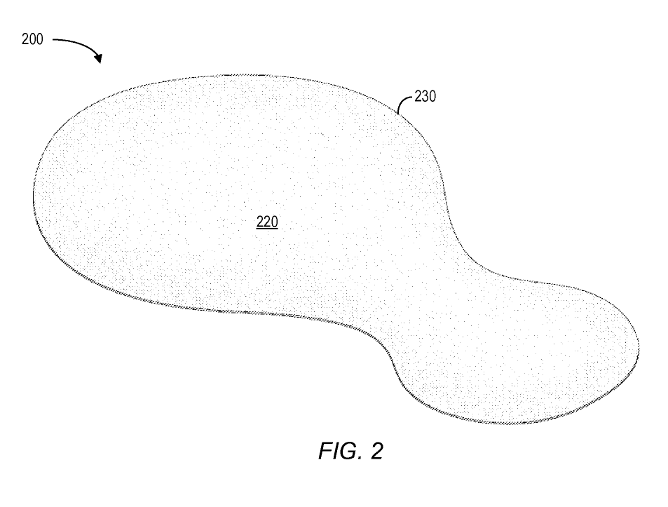

FIG. 2 is a top perspective view of an anti-wrinkle pad 200 according to some embodiments of the present invention. The pad 200 includes an anti-wrinkle portion 220 having a perimeter edge 230. According to some embodiments, the perimeter edge 230 is formed using smooth, tapered curves to reduce existence of sharp angles (e.g., right angles). Such an approach may, for example, help avoid the presence of marks on a person's skin after the pad 200 is removed after a period of time (e.g., overnight or for a few hours during the day).

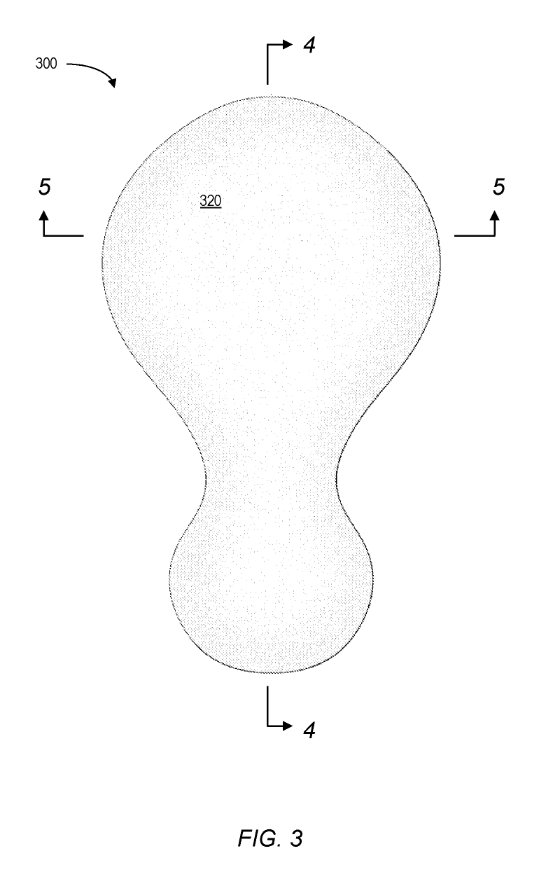

FIG. 3 is a top plan view of an anti-wrinkle pad 300 according to some embodiments of the present invention. As before, the pad 300 includes an anti-wrinkle portion 320 having a perimeter edge. According to some embodiments, the pad 300 has a height (from the top of FIG. 3 to the bottom of FIG. 3) of substantially 200 millimeters. Moreover, according to some embodiments, the pad 300 has a maximum width (from the left of FIG. 3 to the right of FIG. 3) proximate to the top of the pad of approximately 105 millimeters. Moreover, according to some embodiments the pad 300 has a width proximate to the bottom of the pad of approximately 69 millimeters. By having the top of the pad 300 wider as compared to the bottom of the pad 300, a person may more comfortably affix the pad 300 to an area of skin located around a person's chest, torso, neck, face, hands, backside, knees, etc.

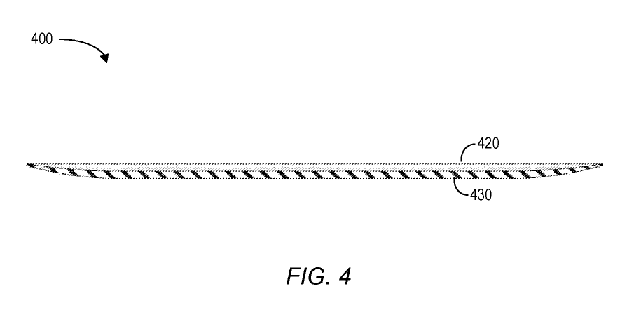

FIG. 4 is a side plan view of the cross-section 4-4 illustrated in FIG. 3 in accordance with some embodiments. The pad 400 includes the anti-wrinkle portion 420 and a substantially flat adhesive substrate 430 affixed to the lower surface of the anti-wrinkle portion 420. The adhesive substrate 430 may, according to some embodiments, be adapted to adhere the anti-wrinkle portion 420 to the person's skin, and the anti-wrinkle portion 420 and adhesive substrate 430 may be arranged in a parallel planer manner in relation to each other. Moreover, according to some embodiments, the adhesive substrate 430 may comprise polydimethylsiloxane. According to some embodiments, both the anti-wrinkle portion 420 and/or the adhesive substrate 430 may provide benefits, including anti-wrinkle characteristics. The anti-wrinkle portion 420 may, for example, provide mechanical resistance to prevent skin folding, the adhesive substrate 430 may provide a barrier to skin dehydration, exfoliation (when removed), and help smooth ridges and/or creases in skin (when removed), etc.

According to some embodiments, the anti-wrinkle portion 420 comprises silicone. For example, the anti-wrinkle portion 420 might include methyl vinyl silicone. More particular, in some embodiments, the anti-wrinkle portion may be formed of: polydimethylsiloxane; silicon dioxide; hydroxyl-terminated silicone fluid; and/or stearic acid. According to some embodiments, portions of the pad 400 may be formed of a material that does not contain any hazardous substances at or above Occupational Safety and Health Administration (“OSHA”) and Workplace Hazardous Materials Information System (“WHMIS”) reportable levels.

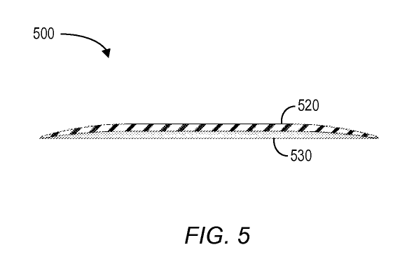

FIG. 5 is a side plan view of the cross-section 5-5 illustrated in FIG. 3 in accordance with some embodiments. According to some embodiments, the pad 500, including an anti-wrinkle portion 520 and an adhesive substrate, has an overall thickness of substantially 5 millimeters. Note that, as illustrated in FIG. 5, the anti-wrinkle portion 520 and adhesive substrate 530 each have a thickness that is largest near the center of the pad 500 and that tapers off toward the perimeter edge. According to some embodiments, the anti-wrinkle portion 520 and adhesive substrate 530 each have a thickness of substantially 2.5 millimeters near the center of the pad 500.

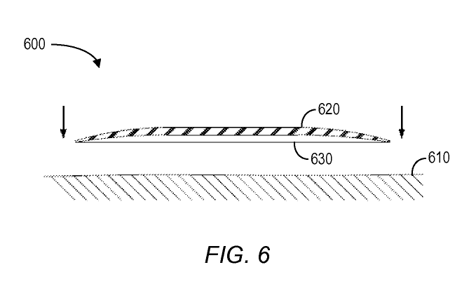

FIGS. 6 through 8 illustrate the application of an anti-wrinkle pad to a person's skin in accordance with some embodiments. As illustrated 600 in FIG. 6, an anti-wrinkle portion 620 may, according to some embodiments, be molded with a mild suction cup cross-section (e.g., via a void in the adhesive layer) that, when adhered to a person's skin 610, attempts to revert to an original form. Consider, for example, movement of the pad, including the adhesive substrate, toward the person's skin 610 as illustrated by the two arrows in FIG. 6.

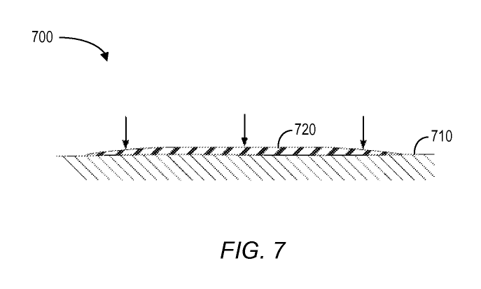

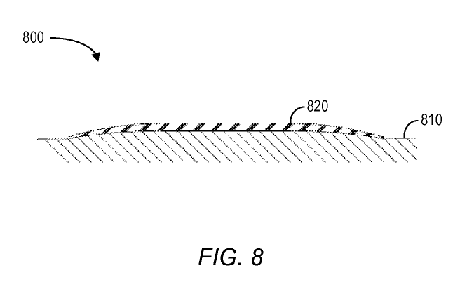

As illustrated 700 in FIG. 7, the person might apply slight pressure to the anti-wrinkle portion 720 (as illustrated by the three arrows in FIG. 7) to adhere the pad to the skin 710. The mild suction cup-cross section of the anti-wrinkle portion 720 has deformed to follow the contours of the person's skin 710. According to some embodiments, this may create a slight tension in the person's skin 710 pulling the skin 710 upward and toward the perimeter edge of the pad. For example, FIG. 8 illustrates 800 how the person's skin 810 has moved up into the suction cup area of the anti-wrinkle portion 820. Such an effect may, according to some embodiments, promote blood flow to the area which may help reduce wrinkles and/or other imperfections in the person's skin.

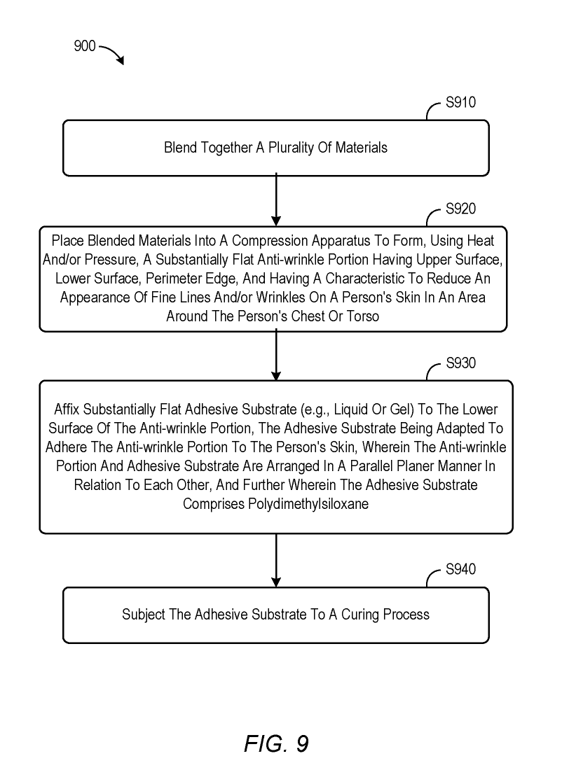

FIG. 9 illustrates an anti-wrinkle pad manufacturing method 900 according to some embodiments of the present invention. The flow charts described herein do not imply a fixed order to the steps, and embodiments of the present invention may be practiced in any order that is practicable. At S910, a plurality of materials may be blended together, such as by kneading various types of silicone together to form thin blended strips.

At S920, the blended material is placed into a compression apparatus to form, using heat and/or pressure, a substantially flat anti-wrinkle portion having an upper surface, a lower surface, a perimeter edge, and having at least one characteristic to reduce an appearance of fine lines and/or wrinkles on a person's skin in an area around the person's chest, torso, neck, face, hands, backside, knees, etc. The compression apparatus might comprise, for example, tooling that creates a cushioned shape of the anti-wrinkle pad (e.g., as opposed to being die-cut from a sheet of material). At S930, a substantially flat adhesive substrate (e.g., a liquid or gel adhesive) is affixed to the lower surface of the anti-wrinkle portion, the adhesive substrate being adapted to adhere the anti-wrinkle portion to the person's skin, wherein the anti-wrinkle portion and adhesive substrate are arranged in a parallel planer manner in relation to each other, and further wherein the adhesive substrate comprises polydimethylsiloxane. At S940, the adhesive substrate is subject to a curing process, such as a heat or air based curing process. The curing process may, for example, be associated with a vulcanization process that improves one or more characteristics of the adhesive substrate (e.g., stickiness, attachment to the anti-wrinkle portion, etc.).

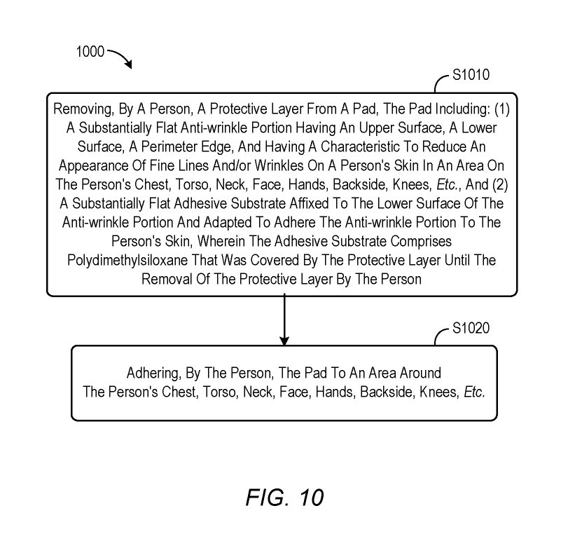

FIG. 10 illustrates a method 1000 of use of an anti-wrinkle pad by a person according to some embodiments of the present invention. At S1010, a person may remove a protective layer from a pad, the pad including: (1) a substantially flat anti-wrinkle portion having an upper surface, a lower surface, a perimeter edge, and having at least one characteristic to reduce an appearance of fine lines and/or wrinkles on a person's skin in an area around the person's chest, torso, neck, face, hands, backside, knees, etc., and (2) a substantially flat adhesive substrate affixed to the lower surface of the anti-wrinkle portion and adapted to adhere the anti-wrinkle portion to the person's skin, wherein the anti-wrinkle portion and adhesive substrate are arranged in a parallel planer manner in relation to each other. The protective layer might be associated with, for example, a pouch, envelope, or other packaging. According to some embodiments, the adhesive substrate comprises polydimethylsiloxane that was covered by the protective layer until the removal of the protective layer by the person. At S1020, the person may adhere the pad to an area around the person's chest, torso, neck, face, hands, backside, knees, etc.

Thus, embodiments may provide a substantial reduction in the appearance of fine lines and/or wrinkles around a person's chest, torso, neck, face, hands, backside, knees, etc. during sleep. As a result, consumers may quickly and easily achieve a more youthful and healthy appearance. Moreover, according to some embodiments, removal of the pad may further provide some degree of exfoliation wherein some amount of dead skin cells may be removed when the pad is removed from the skin. Still further, some embodiments may provide rehydration benefits when the pad is worn by a person. For example, silicone may provide a moisture barrier that acts as a skin breathable water barrier, and as a result, the person's skin may be rehydrated (e.g., overnight). According to some embodiments, the anti-wrinkle pad includes a mixture of ingredients harnessing them to represent a breakthrough, game-changing advance in the field of cosmetics.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific configurations have been described herein, note that any number of other configurations may be provided in accordance with embodiments of the present invention (e.g., shapes other than smooth, tapered curves might be used for the perimeter edge of an anti-wrinkle pad).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. An anti-wrinkle pad, comprising:
a substantially flat anti-wrinkle portion having an upper surface, a lower surface, a perimeter edge, and having at least one characteristic to reduce an appearance of fine lines and/or wrinkles on a person's skin in an area around the person's chest, torso, neck, face, hands, backside, or knees, wherein the anti-wrinkle portion is formed by: (i) blending together a plurality of materials, and (ii) placing the blended materials into a compression apparatus to form, using heat and/or pressure, the anti-wrinkle portion; and
a substantially flat adhesive substrate affixed to the lower surface of the anti-wrinkle portion and adapted to adhere the anti-wrinkle portion to the person's skin, wherein the anti-wrinkle portion and adhesive substrate are arranged in a parallel planer manner in relation to each other, and further wherein the adhesive substrate comprises polydimethylsiloxane.

2. The pad of claim 1, wherein the adhesive substrate comprises a liquid or gel that is subject to a heat-based curing process after being affixed to the lower surface of the anti-wrinkle portion.

3. The pad of claim 2, wherein the pad has a height of substantially 200 millimeters, an overall pad thickness of substantially 5 millimeters, a width proximate to the top of the pad of approximately 105 millimeters, and a width proximate to the bottom of the pad of approximately 69 millimeters.

4. The pad of claim 3, wherein the anti-wrinkle portion and adhesive substrate each have a thickness that is largest near the center of the pad and that tapers off toward the perimeter edge.

5. The pad of claim 4, wherein the anti-wrinkle portion and adhesive substrate each have a thickness of substantially 2.5 millimeters near the center of the pad.

6. The pad of claim 2, wherein the perimeter edge is formed using smooth, tapered curves to reduce existence of sharp angles.

7. The pad of claim 2, wherein the anti-wrinkle portion is molded with a mild suction cup cross-section that, when adhered to the person's skin, attempts to revert to an original form creating a slight tension in the person's skin pulling the skin upward and toward the perimeter edge.

8. The pad of claim 1, wherein the anti-wrinkle portion comprises silicone.

9. The pad of claim 8, wherein silicone comprises methyl vinyl silicone.

10. The pad of claim 1, wherein the anti-wrinkle portion comprises: polydimethylsiloxane; silicon dioxide; hydroxyl-terminated silicone fluid; and/or stearic acid.

11. A method of manufacturing an anti-wrinkle pad, comprising:
blending together a plurality of materials;
placing the blended materials into a compression apparatus to form, using heat and/or pressure, a substantially flat anti-wrinkle portion having an upper surface, a lower surface, a perimeter edge, and having at least one characteristic to reduce an appearance of fine lines and/or wrinkles on a person's skin in an area around the person's chest, torso, neck, face, hands, backside, or knees;
affixing a substantially flat adhesive substrate to the lower surface of the anti-wrinkle portion, the adhesive substrate being adapted to adhere the anti-wrinkle portion to the person's skin, wherein the anti-wrinkle portion and adhesive substrate are arranged in a parallel planer manner in relation to each other, and further wherein the adhesive substrate comprises polydimethylsiloxane; and
subjecting the adhesive substrate to a heat-based curing process.

12. The method of claim 11, wherein the adhesive substrate affixed to the lower surface of the anti-wrinkle portion comprises a liquid or gel.

13. The method of claim 12, wherein the pad has a height of substantially 200 millimeters, an overall pad thickness of substantially 5 millimeters, a width proximate to the top of the pad of approximately 105 millimeters, and a width proximate to the bottom of the pad of approximately 69 millimeters.

14. The method of claim 3, wherein the anti-wrinkle portion and adhesive substrate each have a thickness that is largest near the center of the pad and that tapers off toward the perimeter edge, and further wherein the anti-wrinkle portion and adhesive substrate each have a thickness of substantially 2.5 millimeters near the center of the pad.

15. The method of claim 12, wherein the perimeter edge is formed using smooth, tapered curves to reduce existence of sharp angles.

16. The method of claim 12, wherein the anti-wrinkle portion is molded with a mild suction cup cross-section that, when adhered to the person's skin, attempts to revert to an original form creating a slight tension in the person's skin pulling the skin upward and toward the perimeter edge.

17. The method of claim 11, wherein the anti-wrinkle portion comprises methyl vinyl silicone.

18. The method of claim 11, wherein the anti-wrinkle portion comprises: polydimethylsiloxane; silicon dioxide; hydroxyl-terminated silicone fluid; and/or stearic acid.

19. An anti-wrinkle method, comprising:
removing, by a person, a protective layer from a pad, the pad including:
a substantially flat anti-wrinkle portion having an upper surface, a lower surface, a perimeter edge, and having at least one characteristic to reduce an appearance of fine lines and/or wrinkles on a person's skin in an area around the person's chest, torso, neck, face, hands, backside, or knees, and
a substantially flat adhesive substrate affixed to the lower surface of the anti-wrinkle portion and adapted to adhere the anti-wrinkle portion to the person's skin, wherein the anti-wrinkle portion and adhesive substrate are arranged in a parallel planer manner in relation to each other, and further wherein the adhesive substrate comprises polydimethylsiloxane that was covered by the protective layer until the removal of the protective layer by the person; and
adhering, by the person, the pad to an area around the person's chest, torso, neck, face, hands, backside, or knees.

20. The method of claim 19, wherein the anti-wrinkle portion comprises: polydimethylsiloxane; silicon dioxide; hydroxyl-terminated silicone fluid; and/or stearic acid.
